(19) United States
(12) Patent Application Publication
(10) Pub. No.: US 2026/0298377 A1
(43) Pub. Date: Oct. 1, 2026

(54) ESTABLISHMENT OF A CONNECTION BETWEEN A PIPE AND A BLOCK, AND BLOCK HAVING A PIPE

(71) Applicant: Siemens Energy Global GmbH & Co. KG, Munich, Bayern (DE)

(72) Inventors: Bernd Burbaum, Falkensee (DE); Matthias Gralki, Mülheim an der Ruhr (DE); David Pohle, Berlin (DE)

(73) Assignee: Siemens Energy Global GmbH & Co. KG, Munich, Bayern (DE)

(21) Appl. No.: 19/478,877

(22) PCT Filed: Apr. 3, 2024
(86) PCT No.: PCT/EP2024/058994

§ 371 Date: Oct. 27, 2025

(30) Foreign Application Priority Data
May 2, 2023 (DE) 10 2023 204 049.2

(51) Int. Cl. F16L 13/02; C22C 38/02; C22C 38/40; F16L 13/08; F16L 41/08

(52) U.S. Cl. CPC F16L 13/0236; C22C 38/02; C22C 38/40; F16L 13/08; F16L 41/084

(57) ABSTRACT

A method for establishing a new connection between a block and a pipe, wherein the previous pipe is cut off such that a stub remains on the block, around which a supporting connection is then created so that the new pipe is connectable to the supporting connection by welding.

### CROSS REFERENCE TO RELATED APPLICATIONS

This application is the US National Stage of International Application No. PCT/EP2024/058994 filed 3 Apr. 2024, and claims the benefit thereof, which is incorporated by reference herein in its entirety. The International Application claims the benefit of German Application No. DE 102023204049.2 filed 2 May 2023.

### FIELD OF INVENTION

The invention relates to the establishment of a connection between a pipe and a block, and a block with a pipe.

### BACKGROUND OF INVENTION

Pipes are used to transport media. This can be any fluid, for example gas or oil, that needs to be supplied to a block in general, for example a motor block, a storage block or a combustion part etc.

The pipe can be connected to the block with a screw connection, with a metallurgical connection, that is by soldering or by welding, with the latter not being easy to replace when replacing the pipe.

### SUMMARY OF INVENTION

It is therefore an object of the invention to solve the aforementioned problem.

The object is achieved by a method according to claim 1 and an arrangement according to claim 6.

The dependent claims list further advantageous measures, that can be combined with each other as desired to obtain further advantages.

### BRIEF DESCRIPTION OF THE DRAWINGS

In the drawings:

FIG. 1 shows a block with pipe in an initial condition;

FIGS. 2, 3 show method steps; and

FIG. 4 shows a reworked block with new pipe.

### DETAILED DESCRIPTION OF INVENTION

The description and the figures only show exemplary embodiments of the invention.

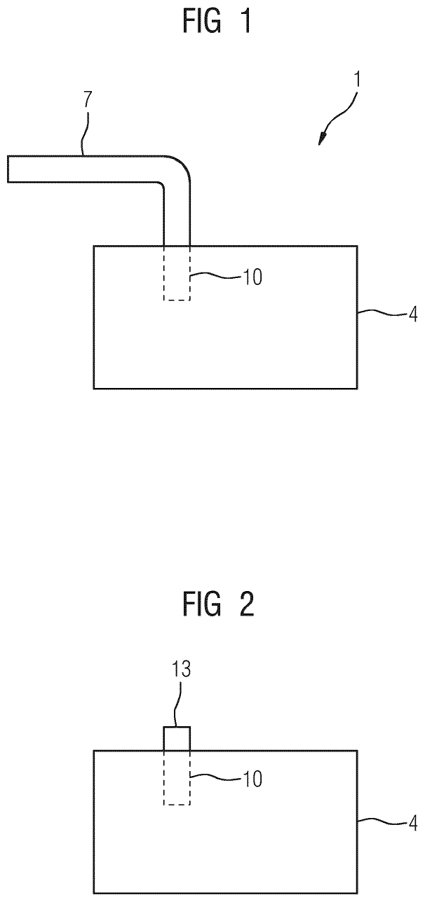

FIG. 1 shows a device 1 of block 4 and a pipe 7 connected to the block 4.

The block 4 is preferably part of an oil supply or distribution system.

The block 4 can preferably have further supply lines or drain lines.

The block 4 is metallic and preferably has a steel. Preferably, this is an austenite.

The pipe 7 is also metallic and preferably comprises a steel. Preferably, this is an austenite.

Preferably, the pipe 7 has the same material as the block 4.

Pipe 7 and block 4 were preferably connected to each other by a connection 10 by soldering or another metallurgical connection at least within the block 4 or with the block 4.

This takes place during establishment, for example by a soldering process in a furnace with block 4 and pipe 7 together, for example with several blocks/pipes together. Here, not only a soldering process as such is performed but also optionally a solder postweld heat treatment of a metal.

A connection by solder always means heat treatment of the entire arrangement for creating the solder connection, which can occur locally in a furnace or only with one block but only in a more complex manner.

The pipe 7 is to be replaced. Simple disengaging is not possible with a solder connection or welded connection.

The pipe 7 is therefore cut off, whereby, however, a part of the pipe 7 is deliberately maintained as a stub 13 above the block 4 (FIG. 2).

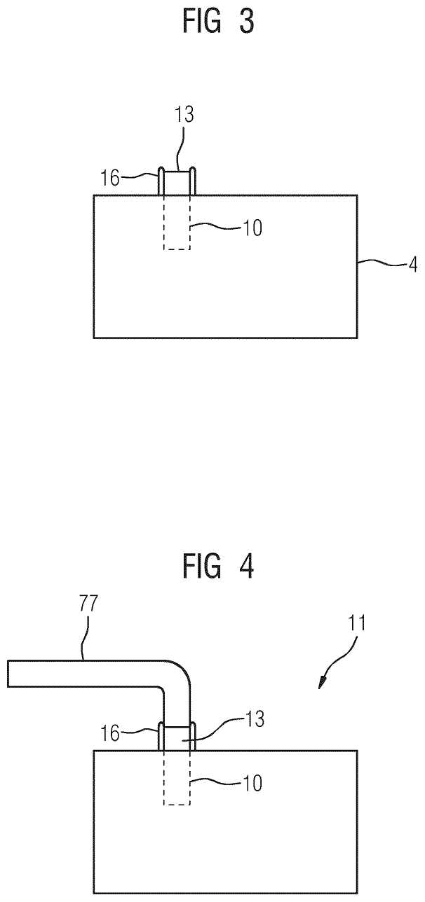

Therefore, to establish a new connection between a new pipe 77 (FIG. 4) and the existing block 4 with the stub 13, a supporting structure 16 is created around and/or on the stub 13 (FIG. 3).

The supporting structure 16 can be made using known additive forming methods, such as LMD or WAAM, that is application of material in form of powder or using a wire by welding. Other additive techniques are also possible.

Preferably, the new pipe 77 has the same material as the pipe 7 and/or preferably as the block 4.

The supporting structure 16 is and/or is created such that the new pipe 77 can be and/or is inserted there.

The new pipe (77) will and/or is then welded to the supporting structure 16 and/or the stub 13.

The welding of the new pipe 77 with the support structure 16 and/or stub 13, optionally also block 4, may occur by pure remelting or also with welding filler material. In this case, preferably the same material as for making the supporting structure 16 is employed as welding filler material.

A connection by solder always means heat treatment for creating the solder connection which can occur locally on site in a plant in an unavailable furnace or also only with one block, but only in a more complex manner. Then, this establishment can be used.

It is preferable for the new metallurgical welded connection between new pipe 77 and supporting structure 16 and/or block 4/stub 13 to not require heat treatment. This can preferably be achieved by a targeted selection of materials.

This then also preferably applies to the material of the block 4 and/or the new pipe 77 as well as to the material of the supporting structure 16 and the welding filler material.

A steel with manganese (Mn), silicon (Si), chromium (Cr), and nickel (Ni) is preferably used for the material of the supporting structure 16.

A steel with chromium (Cr), nickel (Ni), yet if possible preferably without manganese (Mn), but with silicon (Si) should also preferably be used for the material of the block 4.

The proportions of phosphorus (P), nitrogen (N₂) as well as sulfur (S) are to be kept low in both steels in a known manner.

1. A method for establishing an arrangement with a new connection between an existing block and a new pipe, comprising:
cutting off a previous pipe from the block such that a stub remains on the block,
creating a supporting connection around and/or on the stub, and
connecting the new pipe to the supporting connection and/or the stub by welding.

2. The method according to claim 1,
wherein the previous pipe was connected to the block with a soldered connection.

3. The method according to claim 1,
wherein the supporting connection is made using an additive method.

4. The method according to claim 1,
wherein the connection by welding between the new pipe and the supporting connection does not require postweld heat treatment.

5. The method according to claim 1,
wherein a steel with manganese (Mn), silicon (Si), chromium (Cr), and nickel (Ni) is used for the material of the supporting connection, and/or
wherein a steel with chromium (Cr), nickel (Ni), silicon (Si) without manganese (Mn) is used for the material of the block.

6. An arrangement of a block, comprising:
a stub as a part of a cut-off pipe, which protrudes from the block and is connected in the block by solder,
a supporting structure surrounding the stub,
wherein the supporting structure is metallurgically connected to the stub, and to a new pipe, which is metallurgically connected to the supporting structure.

7. The arrangement according to claim 6,
wherein a steel with manganese (Mn), silicon (Si), chromium (Cr), and nickel (Ni) is used for the material of the supporting structure, and/or
wherein a steel with chromium (Cr), nickel (Ni), silicon (Si) without manganese (Mn) is used for the material of the block.

8. The arrangement according to claim 6,
wherein at least the block comprises an austenitic steel.

9. The arrangement according to claim 6,
wherein the material for the block is the same as for the new pipe.

10. The arrangement according to claim 6,
wherein the material for the supporting structure is the same as the material for a welded connection between supporting structure and the new pipe.

11. The method according to claim 3,
wherein the supporting connection is made using welding methods.

12. The arrangement according to claim 6,
wherein the supporting structure is metallurgically connected to the stub, and to a new pipe which is welded to the supporting structure.
